(19) United States
(12) Patent Application Publication
(10) Pub. No.: US 2008/0107850 A1
(43) Pub. Date: May 8, 2008

(54) METHOD TO REDUCE THE ALDEHYDE CONTENT OF POLYMERS

(76) Inventor: Mark Rule, Roswell, GA (US)

Correspondence Address: FRASER CLEMENS MARTIN & MILLER LLC, 28366 KENSINGTON LANE, PERRYSBURG, OH, 43551, US

(21) Appl. No.: 11/971,278

(22) Filed: Jan. 9, 2008

Related U.S. Application Data
(63) Continuation-in-part of application No. 11/527,005, filed on Sep. 26, 2006.
Application No. 11/527,005 is a continuation-in-part of application No. 11/129,160, filed on May 13, 2005, now Pat. No. 7,163,977.

(51) Int. Cl. B32B 1/08; C08K 5/524

(52) U.S. Cl. 428/35.7; 524/128

(57) ABSTRACT

Methods to minimize aldehyde content of a polymer are provided. An effective amount of an additive that contains a P-H functionality is incorporated into the polymer in the presence of an acidic of basic catalyst compositions are also provided.

### CROSS-REFERENCE TO RELATED APPLICATIONS

This application is a continuation-in-part of U.S. patent application Ser. No. 11/527,005 filed Sep. 26, 2006 which is a continuation-in-part of U.S. patent application Ser. No. 11/129,160 filed May 13, 2005, which was issued as U.S. Pat. No. 7,163,977 on Jan. 16, 2007.

### FIELD OF THE INVENTION

The invention relates to methods for reducing aldehyde content of polymers and related compositions.

### BACKGROUND OF THE INVENTION

Polyesters, especially poly(ethylene terephthalate) (PET) are versatile polymers that enjoy wide applicability as fibers, films, and three-dimensional structures. A particularly important application for PET is for containers, especially for food and beverages. This application has seen enormous growth over the last 20 years, and continues to enjoy increasing popularity. Despite this growth, PET has some fundamental limitations that restrict its application in these markets. One such limitation is its tendency to generate acetaldehyde (AA) when it is melt processed. The primary mechanism for AA generation in PET involves a 1,5-sigmatropic rearrangement within the [—C(═O)—OCH₂CH₂—] moiety. Because AA is a small molecule, AA generated during melt processing can migrate through the PET. When PET is processed into a container, AA will migrate over time to the interior of the container. Although AA is a naturally occurring flavorant in a number of beverages and food products, in many instances the taste imparted by AA is considered undesirable. For instance, AA will impart a fruity flavor to water, which detracts from the clean taste preferred for this product.

PET is traditionally produced by the transesterification or esterification of a terephthalate precursor (either dimethyl terephthalate or terephthalic acid, respectively) and ethylene glycol, followed by melt polycondensation. If the end use application for the melt-polymerized PET is for food packaging, the PET is then subject to an additional operation known as solid-state polymerization (SSP), where the molecular weight is increased and the AA generated during melt polymerization is removed. A widely used method to convert the SSP PET into containers consists of drying and remelting the PET, injection molding the molten polymer into a container precursor (preform), and subsequently stretch blow-molding the preform into the final container shape. During the injection molding process AA is regenerated.

Historically, the impact of AA on product taste has been minimized by use of low-activity polymerization catalysts to minimize regeneration of AA during injection molding, use of extended solid-state polymerization times to remove AA prior to injection molding, and use of low-shear screws and balanced hot-runner systems to minimize AA regeneration during injection molding. Typical preform AA levels for PET preforms produced using these methods are 6-8 μg/g (ppm), which is acceptable for many applications where the taste threshold for AA is sufficiently high, or where the useful life of the container is sufficiently short. For other applications, where the desired shelf-life of the container is longer, the product is more sensitive to off-taste from AA, or the prevailing environmental conditions are warmer, it is not possible to keep the AA level below the taste threshold even by employing these methods. For example, in water the taste threshold is considered to be less than about 40 μg/L (ppb), and often a shelf-life of up to two years is desired. For a PET bottle that contains 600 ml of beverage, a preform AA content of 8 ppm can result in a beverage AA level greater than 40 ppb in as little as one month.

Even when acceptable AA levels can be achieved using the above-described methods, achieving those AA levels comes at a significant cost. That cost includes the need to carry out a solid-state polymerization step after the melt polymerization of PET, the need for specially designed injection molding equipment, and the need for low-activity polymerization catalysts. In addition, because AA is regenerated during the injection molding process and the amount generated is critically dependent on the injection molding process conditions, preform manufacturers must continually monitor AA content during container production.

In addition to the afore-mentioned process-related methods, other methods to minimize AA content of polyesters include modification of the polymer itself through the use of lower intrinsic viscosity (IV) resins or the use of lower melting resins. However, lower IV resins produce containers that are less resistant to environmental factors such as stress crack failure. Lower melting resins are achieved by increasing the copolymer content the PET resin, but increasing the copolymer content also increases the natural stretch ratio of the polymer, which translates into decreased productivity in injection molding and blow molding.

Another approach to minimize the AA content of polyesters has been to incorporate additives into the polyester that will selectively react with, or scavenge, the AA that is present. Thus Igarashi (U.S. Pat. No. 4,837,115) discloses the use of amine-group terminated polyamides and amine-group containing small molecules as AA scavengers. Igarashi teaches that the amine groups are effective because they can react with AA to form imines, where the amine nitrogen forms a double bond with the AA moiety. Igarashi teaches that essentially any amine is effective. Mills (U.S. Pat. Nos. 5,258,233; 5,650,469; and 5,340,884) and Long (U.S. Pat. No. 5,266,416) disclose the use of various polyamides as AA scavengers, especially low molecular weight polyamides. Turner and Nicely (WO 97/28218) disclose the use of polyesteramides. These polyamides and polyesteramides are believed to react with AA in the manner described by Igarashi. Rule et. al. (U.S. Pat. No. 6,274,212) discloses the use of heteroatom-containing organic additives that can react with AA to form unbridged 5- or 6-member rings, with anthranilamide being a preferred organic additive.

While these AA scavengers are effective at reducing the AA content of polyesters, they suffer from their own drawbacks. For example, relatively high loadings of polyamides or polyesteramides are needed to effect significant AA reductions, and very significant yellowing of PET can occur on incorporation of these amine-containing additives. The use of anthranilamide also results in some degree of discoloration of PET. This color formation inherently restricts the use of these additives to packaging where the PET can be tinted to mask the color. However, most PET packages in use today are clear and uncolored. In addition, the degree of yellowing caused by these AA scavengers increases with degree of melt processing. This effect is particularly noticeable in recycled PET. Another drawback of the additives disclosed in the above references is that, to a greater or lesser degree, they all are extractable, and therefore can themselves affect the taste of food or beverages packaged in containers made from polyesters incorporating these additives.

A different method of decreasing the AA content of polyesters is disclosed by Rule (U.S. Pat. No. 7,163,977) wherein AA is scavenged by reaction with the P—H bond of metal phosphites in the presence of acidic or basic catalysts. While this approach provides for effective scavenging of AA without yellowing the PET, it requires the use of a particulate additive that is insoluble in the PET matrix. The particulate nature of the metal phosphites employed can result in increased haze in the PET.

In addition to polyesters, aldehydes are present in a number of other polymers, such as polypropylene, polyethylene, polyethylene oxide, polypropylene oxide, polystyrene, polyvinyl chloride, and polyacetal. As in polyesters, in these polymers aldehydes are generated by the thermal or thermal-oxidative degradation of the polymers themselves and/or of additives in the polymers. The aldehydes generated are often detrimental to the taste and odor properties imparted to containers manufactured from these polymers.

Thus, a need exists for new and useful methods and compositions for decreasing the aldehyde content of polymers, including PET, that do not promote yellowing of the polymer and do not impact clarity of containers fashioned therefrom.

### SUMMARY OF THE INVENTION

The present invention provides a method to minimize an aldehyde content of a polymer by incorporating into the polymer an effective amount of an additive that contains a P-H functionality in the presence of an acidic or basic catalyst and is soluble in the polymer matrix. Suitable additives include hypophosphorous acid, phosphorous acid, or an ester or diester of these acids. The additive reacts with the aldehyde by the acid or base catalyzed addition of the P-H moiety across the carbonyl group of the aldehyde to form an alpha-hydroxy phosphonate. The additive can be incorporated into molten polymers such as poly(ethylene terephthalate) homopolymer or copolymer. Further, the aldehyde content of the polymer is reduced by sequestering the aldehyde by the P-H functionality of the soluble phosphite, and secondarily by the inhibition of free-radical reactions that lead to the formation of the aldehydes. In an exemplary embodiment, the additive is present in the polymer at a concentration between about 1 and 5000 ppm, more preferably about 10 and 1000 ppm. The treated polymer can be advantageously molded into a solid article, such as a container for food or beverage. The invention is similarly directed to articles produced from the inventive method.

### DETAILED DESCRIPTION OF EXEMPLARY EMBODIMENTS OF THE INVENTION

The present invention relates to a method which substantially minimizes the aldehyde content of polymers, especially polyesters that are made from ethylene glycol and aromatic diacids or diesters. These polyesters are especially prone to contain aldehydes derived from the thermal degradation of the ethylene linkages. The present invention is particularly useful with PET, but is also applicable to other polyesters and other polymers that contain aldehydes either as impurities or as reaction byproducts. Examples of other polyesters contemplated by this invention include but are not limited to poly(ethylene naphthalate), poly(cyclohexylenedimethylene terephthalate), poly(ethylene isophthalate), and copolymers of these polyesters. Examples of other polymers include but are not limited to polyethylene, polypropylene, polyethylene oxide, polypropylene oxide, polystyrene, polyvinyl chloride, and polyacetal.

In the present invention, aldehydes present in these polyesters are sequestered by incorporation a soluble additive containing a P-H functionality capable of adding across the carbonyl group of the aldehyde to form an alpha-hydroxy phosphonate. This reaction is catalyzed by acids or bases present in the polymer or provided by the additive itself or in conjunction with the additive. Preferably, the additive is phosphorous acid, hypophosphorous acid, or an ester or diester of these acids. Exemplary additives include but are not limited to phosphorous acid, hypophosphorous acid, phenylphosphinic acid, ethyl phosphite, diethyl phosphite, t-butyl phosphite, di-t-butyl phosphite, diethyl phosphite, diphenyl phosphite, and bis(2-ethylhexyl phosphite). The acids or bases required to catalyze this reaction are preferably co-incorporated into the polymer along with the additive containing the P-H functionality, but may also be naturally present in the polymer as acid or basic end groups. In a preferred embodiment, the polymer-soluble additive has a relatively low vapor pressure.

Chemical reactions of this type are known in the literature (see, for example, U.S. Pat. No. 2,579,810), but have not been applied to the reduction of aldehyde content in polymers. While the reaction of aldehydes with a P-H functionality is effective for the formation of alpha-hydroxyphosphonates in the liquid phase, it is surprising that this reaction is effective for sequestering aldehydes in solid phase polymers. For example, compared to the high concentrations of reactants necessary to achieve reasonable conversions and reaction rates in the liquid phase, aldehydes are present in polymers such as polyesters at very low concentrations, typically at levels of 1-100 ppm. Furthermore, generally only low concentrations of the P-H containing moiety and the acid or base catalyst can be tolerated in a polymer, since loadings greater than approximately 1.0 wt % may adversely affect other properties of the polymer, such as clarity or processability. Furthermore, most of the AA present in a PET container sidewall is formed via the room-temperature hydrolysis of vinyl esters and methyl dioxolane. Therefore, the sequestering agents of the present invention are advantageously active at room temperature where the polymer is in a solid state and the diffusional rates for the aldehydes are many orders of magnitude lower than in the liquid phase.

However, as will be seen in the examples presented below, the aldehyde sequestering reaction disclosed in the present specification do occur in polymers at room temperature, even with very low loadings of the metal phosphites and at very low concentrations of aldehydes. That the reaction is so effective under these conditions is both surprising and highly useful, because it provides an efficient method to sequester aldehydes present in polyesters and other polymers.

Unlike most previous methods to sequester AA in PET, wherein the additives contain amine functionality, the additives of the present invention are free of amine functionality. Amines are well known to cause varying degrees of discoloration of a number of polymers, including polyesters. In contrast, the aldehyde scavengers of the present invention do not have such a tendency; in fact, the P-H functionality is effective as a free-radical scavenger and as a mild reducing agent, and as such provides a degree of anti-yellowing activity. The formation of free radicals is especially prevalent during the melt processing of polymers in the presence of oxygen, and is a leading cause of polymer degradation in general and specifically is a mechanism for aldehyde generation. In order to suppress the polymer degradation reactions, organic antioxidants such as hindered phenols and trivalent phosphorous compounds are routinely added to polymers such as polypropylene and polyethylene. These additives are chemically dissimilar to the soluble phosphites of the present invention in that the prior art hindered phenols and trivalent phosphorous compounds do not possess a P-H functionality.

The compositions of the polyesters contemplated in the present invention are not critical, and essentially any monomer or co-monomer can be utilized without adversely affecting the performance of the additives in reducing the aldehyde content. Because of the billions of dollars of product sold per year, polyesters based on terephthalic acid and ethylene glycol are especially important. For polyesters based on terephthalic acid and ethylene glycol, polymerization catalysts including antimony, germanium, titanium, and aluminum have been employed. Because the additives of the present invention are mild reducing agents, use of the additives in non-antimony resins is preferred.

In general for a given additive, higher loadings will result in a higher rate of reaction of the aldehyde as well as a higher amount of aldehyde that can be scavenged. Higher loadings are therefore preferred over lower loadings. The upper limit of the amount of additive to be incorporated is dictated by the rate of aldehyde removal desired, and by the impact of higher loadings on other factors, such as impact on polymer molecular weight, crystallinity, processability, and cost. As will be seen in the examples, loadings of 10-1000 ppm are usually sufficient to achieve the technical effect desired for most applications.

In general, aldehydes are formed during melt processing of polymers such as PET. Because the additives of the present invention react stoichiometrically with aldehydes, it is important that the amount of aldehyde generated after the point of addition does not exceed the capacity of the additive. In order to minimize the amount of phosphite added to a polymer and to maximize the scavenging efficacy, it is desirable to incorporate the additives as late as practical during melt processing. However, except for this constraint, the time in which the additives are added to the present invention is not especially critical, so long as the additives are added prior to forming the final article and sufficient acidic or basic sites are present in the polymer or are provided in conjunction with the additive. For this reason, it is preferred to add the soluble phosphites as melts, dispersions, or solutions immediately prior to the injection molding process. However, because the soluble phosphites of the present invention do not cause significant yellowing of polymers such as PET, it is possible to add these soluble phosphites before a solid-state polymerization process. Addition of the soluble phosphites of the present invention to PET prior to solid-state polymerization provides an effective method to rapidly remove residual AA from the polymer while still providing sufficient scavenging activity to reduce levels during subsequent melt processing. Addition of soluble phosphites at the end of melt polymerization is preferred when the object is to minimize the time required to remove AA or other aldehydes in the solid-state polymerization process, or when the object is to eliminate the need for a solid-state polymerization process altogether. In instances where aldehydes are generated during the polymerization process, such as in the melt-polymerization of PET, it is preferred to add the metal phosphites after the melt polymerization is essentially complete in order to minimize the amount of soluble phosphite required to achieve the intended effect in the final solid articles.

The method of incorporation of the disclosed additives into polyesters is not critical. The additives can be dispersed in a solid or liquid carrier, and mixed with the polyester pellets immediately before injection molding. The additives may also be incorporated by spraying a slurry of the additive onto the polymer pellets prior to drying. The additives may be incorporated by injection of a dispersion thereof into pre-melted polyester. The additives may also be incorporated by making a masterbatch of the additive with the polyester, and then mixing the masterbatch pellets with the polymer pellets at the desired level before drying and injection molding or extrusion. In addition to the use of slurries or dispersions, the additives of the present invention may be incorporated as dry powders. The additives of the present invention that are liquids or low melting solids may be added directly to the polymer pellets or melt as a neat liquid.

Because the additives of the present invention are effective at reducing the AA content of polyesters, where low AA levels are important, the additives are useful for minimizing AA levels in polyester preforms and beverage containers. However, the additives of the present invention are also useful for enabling the practice of modes of polyester container production that are now precluded due to the generation of AA during melt processing. Thus, the additives of the present invention enable the use of high-activity melt-polymerization catalysts, which heretofore have been avoided because of the generation and taste effects of AA. The additives can also enable the use polyesters having elevated melting temperatures which have desirable physical properties but concomitantly higher AA content because of the higher melt-processing temperatures required. The additives can also enable a revision of the design of injection molding equipment, since careful control of AA may be less of a design consideration. The additives also enable new methods of manufacturing of polyester containers, such as direct conversion of polyester melts into preforms without prior solidification and AA removal.

### EXAMPLES

The following examples illustrate the use of the disclosed additives for decreasing the aldehyde content of polymers. The examples are provided to more fully describe the invention and are not intended to represent any limitation as to the scope thereof. In these examples, the effectiveness of the additives in reducing the aldehyde content was determined by measuring the AA content of PET in the presence of the additive, relative to the AA content of identically processed PET without the additive. The AA content was determined by taking a representative portion of the melt-processed polyester, grinding it to pass a 20 mesh (850 micron) screen, and desorbing the contained AA from 0.1 grams of the ground polyester by heating at the specified time and temperature in a sealed 20 mL vial. The desorbed AA in the headspace of the vial was then analyzed using a gas chromatograph equipped with a flame ionization detector.

### Examples 1-2

In the following examples, 500 ppm of diethyl phosphite was blended with PET and the resin injection molded into 24 gram preforms and the AA content measured. Color values were measured on bottles blown from the preforms from the two and three pass material. The b* color values demonstrate that PET containing the diethyl phosphite did not increase in yellowness with increasing heat history, while the haze values demonstrate that the additive did not increase the haze level of the polymer.

| Example | | Preform | Bottle | Bottle | Bottle % |
|---|---|---|---|---|---|
| No. | Description. | AA | L* | b* | Haze |
| 1 | Control | 10.8 | 95.44 | 0.80 | 1.54 |
| 2 | 500 ppm diethyl | 6.48 | 95.44 | 0.71 | 1.62 |
| | phosphite | | | | |

### Example 3-7

The following soluble phosphites were coated at a 500 ppm loading onto dry PET pellets and injection molded into 24 gram preforms. The amount of AA reduction measured is tabulated below:

| Soluble phosphite | Preform AA | % AA Reduction |
|---|---|---|
| None | 6.28 | — |
| di-t-butyl phosphite | 3.83 | 39.8 |
| Phosphorous acid | 4.58 | 28.0 |
| Phenylphosphinic acid | 4.23 | 33.5 |
| Bis(2-ethylhexyl phosphite) | 4.96 | 22.0 |

### Examples 8-13

The following examples show how combining a soluble phosphite with a basic catalyst may enhance the aldehyde scavenging activity of the P-H functionality. In these examples, the additives were coated at a 500 ppm loading onto dry PET pellets and injection molded into 24 gram preforms. The amount of AA reduction measured is tabulated below.

| Soluble phosphite | Preform AA | % AA Reduction |
|---|---|---|
| None | 6.5 | — |
| Phosphorous acid | 4.8 | 23.2 |
| Phosphorous acid + 500 ppm sodium | 3.1 | 50.5 |
| acetate | | |

The invention has been described with reference to a preferred embodiment. Modifications and alternatives will be apparent to the skilled artisan upon reading and understanding the preceding detailed description. It is intended that the invention be construed as including all such modifications and alternatives that fall within the scope of the appended claims or equivalents thereof.

The foregoing disclosure includes that best mode of the inventor for practicing the invention. It is apparent, however, that those skilled in the relevant art will recognize variations of the invention that are not described herein. While the invention is defined by the appended claims, the invention is not limited to the literal meaning of the claims, but also includes these variations.

What is claimed is:

1. A method to minimize an aldehyde content of a polymer that comprises incorporating into the polymer an effective amount of at least one polymer-soluble compound possessing a P-H functionality in the presence of an effective amount of at least one of an acidic group and a basic group.

2. The method of claim 1, wherein the polymer-soluble compound is a phosphite.

3. The method of claim 1, wherein the polymer-soluble compound is a hypophosphite.

4. The method of claim 1, wherein the effective amount of at least one of an acidic group and a basic group are incorporated into the polymer separately or in conjunction with the polymer soluble compound possessing a P-H functionality.

5. The method of claim 1, wherein the polymer-soluble compound comprises at least one of an acidic functionality and a basic functionality.

6. The method of claim 1, wherein the compound possessing at least one P-H functionality is incorporated into a molten polyester.

7. The method of claim 6, wherein the polyester is at least one of a poly(ethylene terephthalate) homopolymer and a poly(ethylene terephthalate) copolymer.

8. The method of claim 1, wherein the polymer-soluble compound possessing a P-H functionality is incorporated into a polymer at a concentration between about 1 and 2000 ppm.

9. The method of claim 1, wherein the polymer-soluble compound possessing a P-H functionality is incorporated into the polymer at a concentration between about 10 and 500 ppm.

10. The method of claim 1, wherein the polymer is molded into a solid article.

11. The method of claim 10, wherein the solid article is a container.

12. The method of claim 10, wherein the polymer comprises a polyester.

13. The method of claim 12, wherein the polyester is at least one of a poly(ethylene terephthalate) homopolymer and a poly(ethylene terephthalate) copolymer.

14. A method of forming a polyester container for storing food or beverage comprising combining at least one polymer soluble compound possessing a P-H functionality and at least one of a molten poly(ethylene terephthalate) homopolymer and a molten poly(ethylene terephthalate) copolymer to form a treated material and molding said treated material to form said container.

15. A polyester composition having an improved flavor retaining property, comprised of dicarboxylic acid units and diol units, and including a polymer soluble additive that possesses at least one P-H functionality, said additive being present at a concentration between about 10 and 2000 ppm.

21. A container for food or beverage products, the container being comprised of a polyester including a polymer soluble additive that possesses at least one P-H functionality, said additive being present at a concentration between about 10 and 2000 ppm.
